(19) United States
(12) Patent Application Publication
(10) Pub. No.: US 2009/0133053 A1
(43) Pub. Date: May 21, 2009

(54) METHOD AND APPARATUS TO PERFORM TELEVISION PROGRAM INSERTION DURING COMMERCIAL TIME SLOT INTERVAL

(75) Inventors: SIG HAROLD BADT, JR., RICHARDSON, TX (US); CHAO KAN, FRISCO, TX (US)

Correspondence Address: RG and Associates, 1103 Twin Creeks, Allen, TX, 75013, US

(73) Assignee: ALCATEL LUCENT, Paris (FR)

(21) Appl. No.: 11/941,089

(22) Filed: Nov. 16, 2007

(51) Int. Cl. H04N 7/025

(52) U.S. Cl. 725/32

(57) ABSTRACT

A system and method of television program insertion during an advertisement time slot may include a set top box (STB) receiving program and advertisement content from a digital subscriber line access module (DSLAM). Program content may be substituted for advertisement content during a regularly scheduled advertisement time slot to attract viewer's who are surfing channels for desirable content. The program content may be limited to a preview or sample of the program. Subsequent advertisement time slots may offer regularly scheduled advertisements.

### TECHNICAL FIELD OF THE INVENTION

The present invention is generally related to advertisement insertion, and more particularly to the advertisement and content distribution in Internet Protocol multicast networks.

### BACKGROUND OF THE INVENTION

Television viewers sometimes “surf” channels. That is to say, they rapidly change from channel to channel searching for a program they want to watch. It is possible that, while surfing, a viewer may come to a channel that is currently showing a program the viewer would like to watch, but unfortunately that program is currently showing a commercial. Because the viewer only sees the commercial, the viewer quickly surfs past the program and ends up watching another channel or nothing at all. As such, what is needed is a solution to overcome the problems and limitations described above.

### SUMMARY OF THE INVENTION

The present invention provides a system, method, and computer readable medium for advertisement insertion with free samples. Effectively, the present invention allows television viewers to bypass a commercial if one is currently airing when initially tuning in to a television program.

Once a viewer locates and maintains a program to watch, the viewer will then see all forthcoming commercials, as they would normally appear. Since viewers are able to bypass all commercials or advertisements currently airing until a desired program is located and maintained, the viewers would know exactly what is on each channel as they “surf” for something to watch. They are, therefore, more likely to become Internet Protocol Television (IPTV) service consumers. Furthermore, the present invention is equally as appealing to broadcasters in view of the fact that broadcasters are more likely to distribute their programs over IPTV services.

The present invention is related to broadcast television programs that are distributed using Internet Protocol (IP) multicast technology. There is currently no known method to reliably make this technology work utilizing satellite, cable, or terrestrial broadcast communications. This ultimately gives Internet Protocol (IP) multicast a unique advantage over its competition.

This technology takes advantage of two facts:
1. An IP multicast network that distributes broadcast television programs can insert custom commercials on a per-user basis; and
2. A Digital Subscriber Line Access Module (DSLAM) can keep track of what program a viewer is watching.

In one example embodiment of the present invention, a method of television program insertion during an advertisement time slot includes tuning into a channel via user interaction with a set top box during an advertisement time slot of an otherwise regularly scheduled program, and receiving a stream of video content containing at least a portion of the regularly scheduled program currently being offered on the channel in response to the tuning operation.

In one example embodiment of the present invention, a system of television program insertion during an advertisement time slot includes a set top box configured to receive and display media content, and a digital subscriber line access module (DSLAM) which provides content to the set top box and switches between providing the user with a regularly scheduled program and advertisements, and during an advertisement time slot and in response to a channel change operation, the DSLAM checks the status of at least one bit stored in memory and provides a user with at least one of a portion of the regularly scheduled program and an advertisement depending on the status of the at least one bit.

In one example embodiment of the present invention, a method of television program insertion during an advertisement time slot includes tuning into a channel via user interaction with a set top box (STB) during an advertisement time slot of an otherwise regularly scheduled program, and receiving a stream of video content containing at least a portion of the regularly scheduled program instead of advertisements regularly scheduled to be offered during said advertisement time slot, and wherein the at least a portion of the regularly scheduled program is inserted into the stream of video content as a result of at least one bit stored in memory indicating whether the user recently accessed said channel.

### BRIEF DESCRIPTION OF THE DRAWINGS

FIG. 1 illustrates a block diagram depicting an aspect of the present invention wherein advertisement insertion is not required;

FIG. 2 illustrates a block diagram depicting an advertisement insertion feature according to an example embodiment of the present invention;

FIG. 3 illustrates a diagram depicting a system in accordance with an example embodiment of the present invention;

FIG. 4 illustrates a diagram depicting a system in accordance with another example embodiment of the present invention;

FIG. 5 illustrates a diagram depicting a system in accordance with yet another example embodiment of the invention.

### DETAILED DESCRIPTION OF THE DRAWINGS

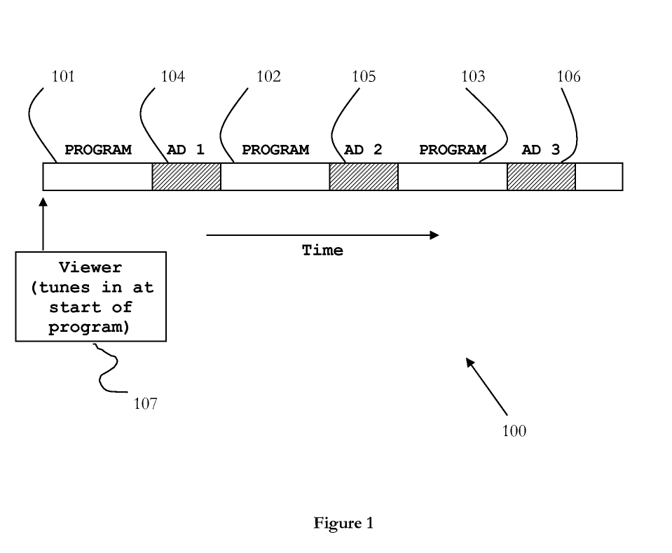

Referring to FIG. 1, a viewer 107 may tune into a channel 100 and begin watching a television show. Beginning with a first segment of the program 101, the viewer 107 may be inclined to continue watching the program through segment 101 shown on channel 100. As time progresses, the show will eventually reach a specified commercial/advertisement (“AD”). In FIG. 1, AD1 104 represents the first AD in a sequence after program segment 101. The program segments 101, 102 and 103 may represent the entire show and the intermittent advertisement intervals 104, 105 and 106 may represent the time slots where commercials are shown to the viewer 107.

A common scenario often experienced by a viewer 107 watching television may include the viewer 107 tuning into channel 100 during one of the AD time slots 104, 105 or 106. In such a case, the viewer 107 may be more inclined to change the channel due to the displaying of an advertisement during one of the AD time slots 104, 105 or 106. Generally, the preference of the viewer 107, would be to change the channel away from channel 100 upon viewing an advertisement displayed on the viewer's television, except in rare circumstances that include highly anticipated advertisements, such as, for example, the national football league (NFL) Super Bowl.

One alternative to displaying an advertisement during an advertisement time slot interval would be to offer a portion or sample of the television program during one or more of the advertisement time slot intervals 104, 105 and 106. The program sample may be created automatically by recording a section of the program preceding an advertisement time slot interval.

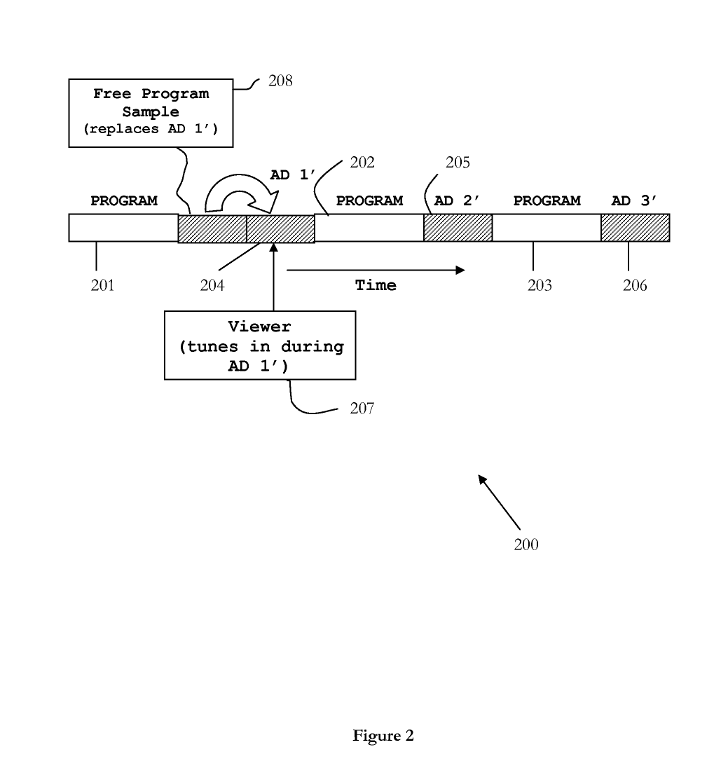

Referring to FIG. 2, if a viewer 207 tunes into a television channel 200 during the time slot interval AD 1′ 204, having missed program segment 201, the free program sample 208 may be substituted for the advertisement that would normally be provided to the viewer 207. Instead of viewing an advertisement AD 1′ 204, the viewer 207 will view a portion of the show as provided in the free program sample 208.

The free program sample 208 may be a repeated portion of a section of the program 201 preceding the commercial interval 204, or may instead be a summary of the portion of the program 201 that came before the commercial. Alternatively, the sample 208 may be a pre-recorded trailer representing a preview of the entire show including parts from segments 201, 202 and 203, or, may even be other content used to persuade the viewer 207 to stop channel surfing and begin watching the contents of channel 200.

Once the viewer 207 commits to watching the television channel 200, over time, the viewer 207 will continue to see the regularly scheduled advertisements (e.g., AD 2′ 205 and AD 3′ 206) and the program segments (e.g., 202 and 203) as originally intended. Furthermore, the viewer 207 may be able to view the contents of AD 1′ 204 subsequent to its originally intended time slot interval 204. The commercials originally scheduled for time slot interval 204 may be forwarded to replace one or more of the next advertisement intervals 205/206, or, alternatively, the commercials may be tacked on to one or more of time slot intervals 202/203.

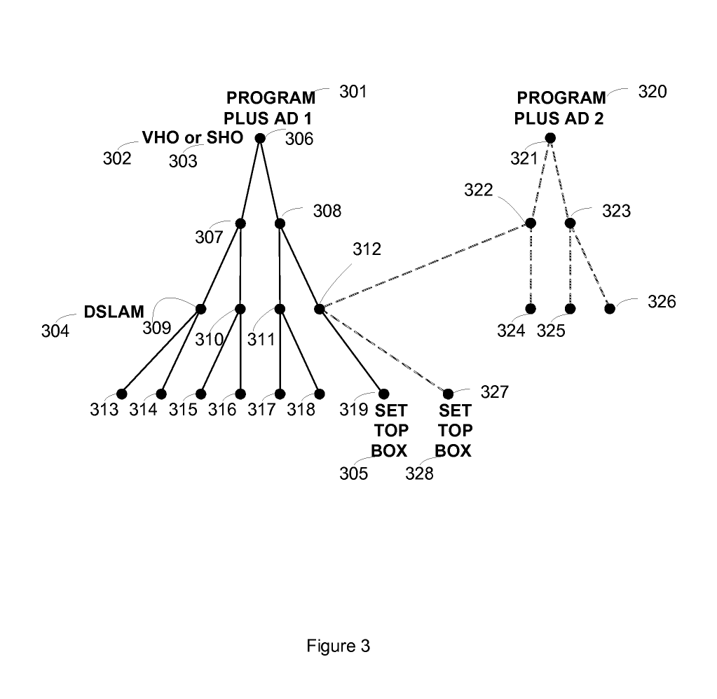

Commercial substitution may be used in an IP multicast and/or unicast network. FIG. 3 illustrates an example commercial substitution scenario used in a multicast IP network. FIG. 3 illustrates two multicast trees, tree one 301 and tree two 320. One or both trees 301 and 320 may be used to deliver packets by way of packet forwarding devices (switches, routers, DSLAMS, etc.) 306, 307, 308, 309, 310, 311, 312, 313, 314, 315, 316, 317, 318 and 319 from tree one 301. Packet delivery may be accomplished by packet forwarding devices 321, 322, 323, 324, 325, 326 and 327 from tree 320. The packets may be sent from a VHO 302 or SHO 303.

Tree one 301 is designated to distribute a broadcast television program plus a set of advertisements AD1. Tree two 320 may distribute the same broadcast television stream plus a different set of advertisements AD2. A Set Top Box (STB) 305 may be configured to receive packets from multicast tree one 301, and the other STB′ 328 may be configured to receive packets from multicast tree two 320 while both STBs 305 and 328 are coupled in communication with the same DLSAM 312.

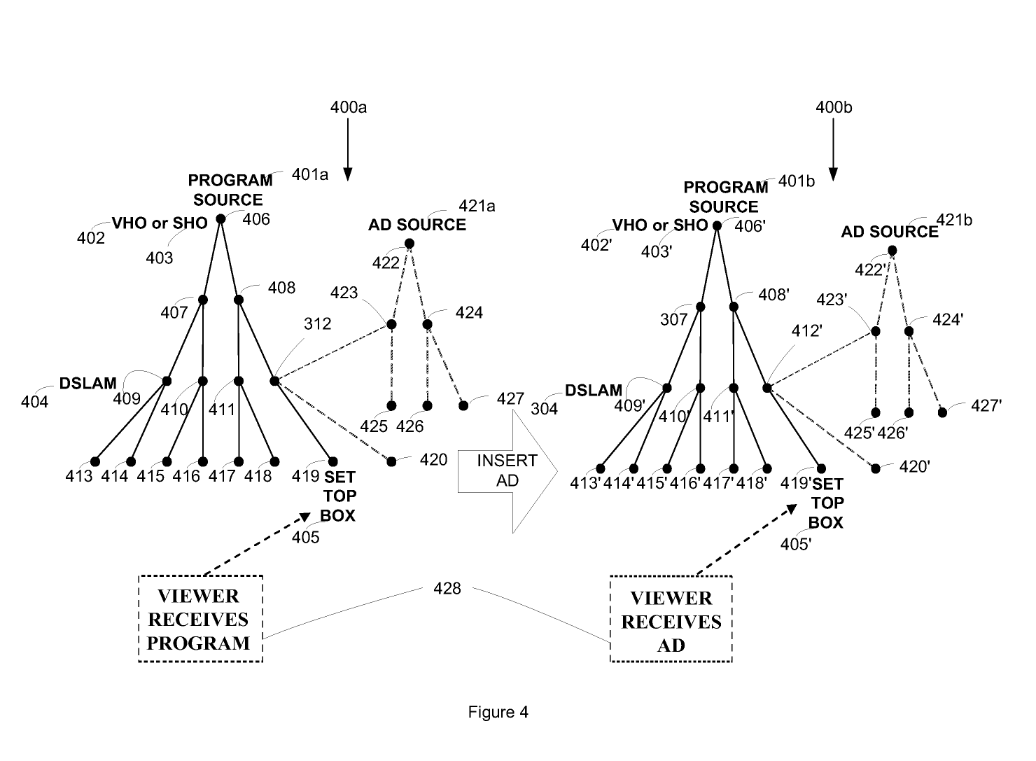

FIG. 4 illustrates two separate multicast tree configurations 400a and 400b. Each of the two multicast tree configurations 400a and 400b contain two respective multicast trees, tree one 401a and tree two 421a within 400a, and tree one 401b and tree two 421b within 400b.

The difference between FIG. 3 and FIG. 4 is that FIG. 4 has separate trees used to distribute program and AD content. For example, program source trees 401a and 401b are configured to distribute a broadcast television program and AD source trees 421a and 421b are configured to distribute commercials.

Multicast configuration one 400a represents the content of a television channel being viewed by viewer 428. The content may include a program and/or AD or combinations of both. Tree one 401a and tree two 421a deliver packets by way of packet forwarding devices 406, 407, 408, 409, 410, 411, 412, 413, 414, 415, 416, 417, 418, 419 and 420 from tree one 401a, and by way of packet forwarding devices 422, 423, 424, 425, 426, 427 from AD source tree 421a. The packets may originate from a VHO 402 or SHO 403.

According to an example embodiment of the general inventive concept, when it comes time to display a commercial/advertisement, the Digital Subscriber Line Access Module (DSLAM) 412 switches the Set Top Box (STB) 405 from program source tree 401a to AD source tree 421a, which contains the advertisement content.

The DSLAM 404 (which represents one or more of DSLAMs 409-412) may detect the first time a viewer tunes to a new program. If that newly viewed program is currently presenting a commercial, the DSLAM 404 replaces the commercial with a section of the program. This section of the program is referred to as a “free program sample.” To a network, a free program sample appears to be nothing more or nothing less than a commercial.

Multicast configuration 400b illustrates the process of switching from a program source tree 401b to an AD source tree 421b. The dotted line between DSLAM 412′ and STB 405′ indicates the content being received at the STB 405′ from the AD source tree 421b and not from the program source tree 401b. Multicast configuration two 400b illustrates the same television channel as in configuration one 400a except in configuration 400b the viewer 428 is viewing a commercial.

Tree one 401b and tree two 421b deliver packets by way of packet forwarding devices 406′, 407′, 408′, 409′, 410′, 411′, 412′, 413′, 414′, 415′, 416′, 417′, 418′ and 419′ from tree one 401b, and by way of packet forwarding devices 422′, 423′, 424′, 425′, 426′, 427′ from tree 421b. The packets are sent from the VHO 402′ or SHO 403′. The DSLAM 404′ switches the STB 405′ from the tree that contains the program to the tree that contains the commercials. That way, the viewer then views the commercial content from the AD source tree 421b.

In practice, FIG. 3 and FIG. 4 are greatly simplified, however, it is important to note that in both FIGS. 3 and 4, the DSLAMs 304 ((which represents one or more of DSLAMs 309-312)/404 (which represents one or more of DSLAMs 409-412) and 404′ (which represents one or more of DSLAMs 409′-412′) are configured to control what commercial a viewer receives. From a network point of view, a free program sample is similar to a commercial. A free program sample may be inserted into a program using whatever technology is used to insert commercials.

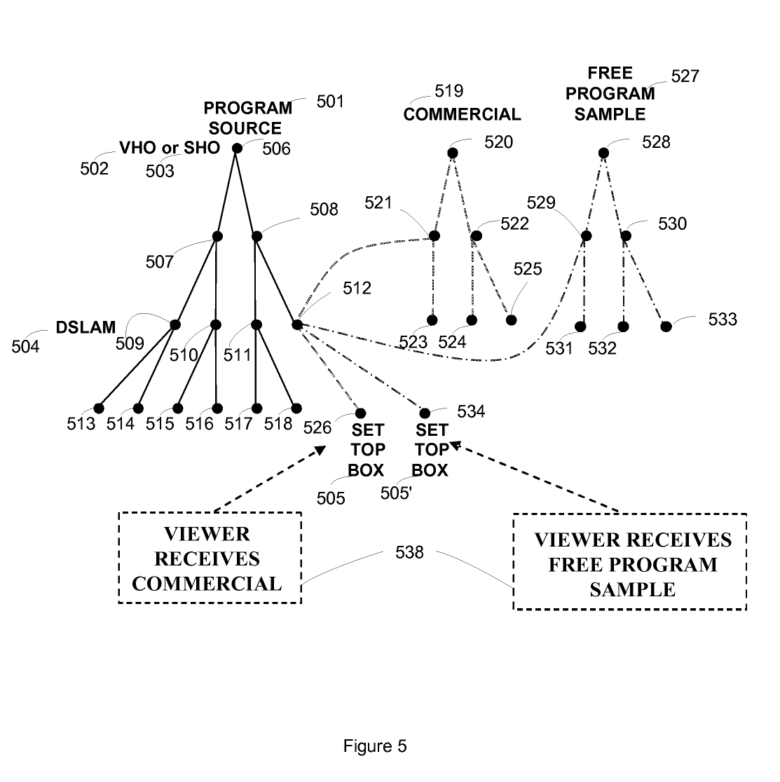

Referring to FIG. 5, three multicast trees 501, 519 and 527 are shown. Tree one represents program source 501, tree two commercial source 519, and tree three free program sample 527. Program source tree 501 delivers packets by way of packet forwarding devices 506, 507, 508, 509, 510, 511, 512, 513, 514, 515, 516, 517 and 518, from the program source tree 501, and sent from the VHO 502 or SHO 503. Commercial tree 519 delivers packets by way of packet forwarding devices 520, 521, 522, 523, 524, 525, and free program sample tree 527 delivers packets by way of packet forwarding devices 528, 529, 530, 531, 532, 533.

At the point of packet forwarding device 512 where a commercial would be inserted, the DSLAM 504 switches the STB 505 from the accessibility of both program source tree 501 and commercial tree 519 to free program sample tree 527. In a normal scenario, STB 505 would receive program content from program source 501 and during a commercial interval would receive a commercial packet at the point of delivery 526 from commercial tree 519.

Once a transition from program source tree 501 and commercial source tree 519 has occurred, a free program sample may be inserted via free program sample tree 527 as a replacement to the regularly scheduled content. After the transition, the STB 505′ may receive the prerecorded program sample at the point of delivery 534 during a regularly scheduled commercial time slot interval. The prerecorded program sample may then be viewed by a viewer 538 in place of the regularly scheduled commercial.

Another example embodiment may include the DSLAM 504 monitoring and keeping track of which programs are being received by the STBs within the control of that particular DSLAM 504. The DSLAM 504 may store one bit of data per channel per STB indicating whether or not this particular STB has already accessed some portion of a current program.

Each time a new program begins the bits for that program may all be set to zero. When a viewer tunes into a new program on another channel, the DSLAM 504 may perform a couple of operations. For example, the DSLAM 504 may determine whether or not the channel is currently in a commercial time slot interval, and the status of the free sample bit. If, for example, the program has been interrupted by a commercial and the bit is zero, the DSLAM 504 may send the STB 505′ a free program sample and set the bit to one. If the program is not in a commercial and/or the bit is one, the DSLAM 504 may continue to display the program in the normal manner and set the bit to one.

In one scenario, if a viewer tunes in to a channel for the first time, then rapidly changes to a second channel, and then rapidly returns to the first channel, the viewer may no longer require a free sample program on the first channel. There would be no need to provide a viewer a second instance of a free program sample because the viewer actions indicate that he/she already knows what program is airing on that channel.

A similar scheme can be implemented using the STB. In this scheme the STB would send out a request for either a commercial or a free program sample. The STB would designate one bit per channel and use an algorithm similar to the one described above. The STB-based scheme may have the additional advantage that it can work with satellite, cable, and terrestrial broadcast.

While preferred embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

What is claimed is:

1. A method of television program insertion during an advertisement time slot, the method comprising:
tuning into a channel via user interaction with a set top box during an advertisement time slot of an otherwise regularly scheduled program; and
receiving a stream of video content containing at least a portion of said regularly scheduled program currently being offered on said channel in response to the tuning operation.

2. The method of claim 2, wherein the at least a portion of the regularly scheduled program is pre-recorded and inserted into the advertisement time slot as a result of the viewer's channel change operation.

3. The method of claim 1, wherein the at least a portion of the regularly scheduled program is created and inserted into the advertisement time slot as a result of the user's channel change operation.

4. The method of claim 1, wherein the at least a portion of the regularly scheduled program is the portion of the program that was offered on said channel substantially near the moment in time before the advertisement time slot began.

5. The method of claim 1, wherein the at least a portion of the regularly scheduled program is inserted into the content stream of said channel via the digital subscriber line access module.

6. The method of claim 1, wherein subsequent regularly scheduled program content and subsequent advertisement content are resumed subsequent to the insertion of the at least a portion of the regularly scheduled program content during the advertisement time slot.

7. The method of claim 1, wherein at least one of the set top box and the digital subscriber line access module stores at least one bit representing whether the user has accessed said channel.

8. A system of television program insertion during an advertisement time slot, the system comprising:
a set top box configured to receive and display media content; and
a digital subscriber line access module (DSLAM) which provides content to the set top box and switches between providing the user with a regularly scheduled program and advertisements, and during an advertisement time slot and in response to a channel change operation, the DSLAM checks the status of at least one bit stored in memory and provides a user with at least one of a portion of the regularly scheduled program and an advertisement depending on the status of the at least one bit.

9. The system of claim 8, wherein the status of the at least one bit is based on the last channel accessed by the user.

10. The system of claim 8, wherein the regularly scheduled program and advertisements are provided from a first multicast tree to the DSLAM and the at least a portion of the regularly scheduled program is provided from a second multicast tree separate from said first multicast tree to the DSLAM.

11. The system of claim 8, wherein the regularly scheduled program is provided from a first multicast tree to the DSLAM, the advertisements are provided from a second multicast tree to the DSLAM, and the at least a portion of the regularly scheduled program is provided from a third multicast tree to the DSLAM, and where the first, second and third trees are separate from one another.

12. The system of claim 8, wherein the DSLAM is coupled to at least two multicast trees and switches between the two trees depending on the value of the at least one bit to provide the set top box with content from only one tree at a time.

13. The system of claim 8, wherein the DSLAM is coupled to at least two multicast trees and switches between the two trees to stop the content of the advertisements and to begin the at least a portion of the regularly scheduled program in response to the channel change operation.

14. A method of television program insertion during an advertisement time slot, the method comprising:
tuning into a channel via user interaction with a set top box (STB) during an advertisement time slot of an otherwise regularly scheduled program; and
receiving a stream of video content containing at least a portion of said regularly scheduled program instead of advertisements regularly scheduled to be offered during said advertisement time slot, and wherein the at least a portion of the regularly scheduled program is inserted into the stream of video content as a result of at least one bit stored in memory indicating whether the user recently accessed said channel.

15. The method of claim 14, wherein the STB designates at least one bit per channel offered, and sends a request for at least one of a commercial and a free program sample as a result of the status of the at least one bit.

16. The method of claim 14, wherein the status of the least one bit includes one of “0” and “1”.

17. The method of claim 16, wherein the status of the at least one bit is based on the last channel accessed by the user.

18. The method of claim 14, wherein the advertisements regularly scheduled to be offered during said advertisement time slot are forwarded to replace a one or more of the next advertisement time slots.

19. The method of claim 14, wherein the advertisements regularly scheduled to be offered during said advertisement time slot are tacked on to the next advertisements regularly scheduled for the next advertisement time slots.

20. The method of claim 14, wherein the advertisements regularly scheduled to be offered during said advertisement time slot are tacked on to the next advertisements regularly scheduled for more than one of the next advertisement time slots.
